(19) United States
(12) Patent Application Publication
(10) Pub. No.: US 2005/0284564 A1
(43) Pub. Date: Dec. 29, 2005

(54) Process for encapsulation of cellulose based substrates using adhesive

(76) Inventors: Brian C. Horsfield, Federal Way, WA (US); Richard H. Young SR., Maple Valley, WA (US); H. Donald Muise JR., Mira Loma, CA (US); Gerald Wilhite, Bowling Green, KY (US); Herbert D. Muise, Tumwater, WA (US)

Correspondence Address: WEYERHAEUSER COMPANY;INTELLECTUAL PROPERTY DEPT., CH 1J27, P.O. BOX 9777, FEDERAL WAY, WA, 98063, US

(21) Appl. No.: 10/879,821

(22) Filed: Jun. 29, 2004

(51) Int. Cl. B29C 65/00

(52) U.S. Cl. 156/199; 156/285; 156/213

(57) ABSTRACT

A method for encapsulating a cellulose based substrate with polymeric film involves applying an adhesive to at least one of the respective films and providing a pressure differential between an environment defined between the films and an environment external to the films so that conformance of the films to the cellulose based substrate is promoted. The cellulose based substrate is encapsulated by the polymeric films and the films are sealed around the peripheral edges of the cellulose based substrate as well as edges that are defined by slots and cutouts.

### FIELD OF THE INVENTION

The present invention relates to methods for encapsulating a cellulose based substrate with a polymeric film and products formed thereby.

### BACKGROUND OF THE INVENTION

Containers made from fibreboard are used widely in many industries. For example, fibreboard containers are used to ship products that are moist or packed in ice such as fresh produce or fresh seafood. It is known that when such containers take up moisture, they lose strength. To minimize or avoid this loss of strength, moisture-resistant shipping containers are required.

Moisture-resistant containers used to date have commonly been prepared by saturating container blanks with melted wax after folding and assembly. Wax-saturated containers cannot be effectively recycled and must generally be disposed of in a landfill. In addition, wax adds a significant amount of weight to the container blank, e.g., the wax can add up to 40% by weight to the container blank.

Other methods for imparting moisture-resistance to container blanks have included impregnation with a water-resistant synthetic resin or coating the blank with a thermoplastic material. In the latter case, forming water-resistant seals around container blank peripheral edges and edges associated with slots or cutouts in the container blank has been an issue. When seals along these edges are not moisture resistant or fail, moisture can be absorbed by the container blank with an attendant loss of strength. In addition, obtaining consistent and reproducible bonding of the thermoplastic material to the container blank and around edges has been a challenge.

Faced with the foregoing, the present inventors have worked to develop a method for producing a cellulose based substrate encapsulated with a polymeric film that is recyclable and lighter in weight than previous wax-saturated containers and does not suffer from inconsistent bonding, sealing, and conformance of a film to the substrate.

### SUMMARY OF THE INVENTION

Fresh produce growers, distributors of fresh produce and fresh produce retailers will find the cellulose based substrates in the form of encapsulated container blanks of the present invention desirable for a number of reasons, including their recyclable nature and lighter weight compared to conventional wax-saturated blanks. The lighter weight will translate into reduced shipping costs. Manufacturers of container blanks will find the methods of the present invention desirable because the methods provide an effective way to reproducibly manufacture encapsulated container blanks without the need to use wax that inhibits recycling of the container. Furthermore, the clarity of graphics associated with container blanks formed in accordance with the methods of the present invention are superior to the clarity of graphics associated with wax-impregnated container blanks.

In one aspect, the present invention is directed to a method for encapsulating a cellulose based substrate with a polymeric film. In accordance with this aspect of the present invention, a cellulose based substrate having a first surface, a second surface opposite the first surface and a cellulose based substrate periphery is provided. An adhesive is applied to at least a portion of a first moisture resistant film that is positioned adjacent the first surface of the cellulose based substrate and a second polymeric film is positioned adjacent the second surface of the cellulose based substrate. Adhesive may optionally be applied to at least a portion of the second polymeric film. Both the first polymeric film and the second polymeric film extend beyond the cellulose based substrate periphery where they overlap. The adhesive, first polymeric film and the second polymeric film cooperate to define an envelope that substantially encapsulates the cellulose based substrate. A pressure differential is provided between an environment within the envelope and an environment exterior of the envelope. This pressure differential promotes the conformation of the first polymeric film and the second polymeric film to the cellulose based substrate, particularly its peripheral edges, and any cutouts or slots provided therein. The first and second polymeric films adjacent the cellulose based substrate periphery and any edges defining slots and cutouts are bonded to each other by the adhesive in order to provide a moisture resistant seal around these exposed edges.

In accordance with the present invention, the pressure differential can be provided a number of different ways, including the use of vacuum chambers, pressure chambers, and combinations thereof. In accordance with the present invention, excess polymeric film can be trimmed from around the peripheral edges of the cellulose based substrate as well as within any slots or cutouts that are provided in the cellulose based substrate.

Polymeric film encapsulated cellulose based substrates formed in accordance with the present invention can be folded and secured to form containers suitable for containing moist materials such as fresh produce. After use, the containers can be recycled and the polymeric film separated from the cellulose based materials forming the container.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a perspective view of one surface of a container blank encapsulated with a polymeric film by a method carried out in accordance with the present invention;

FIG. 2 is a perspective view of a container formed from the container blank of FIG. 1;

FIG. 3 is a section taken through line 3-3 of FIG. 1;

FIG. 4 is a perspective view of one surface of a second embodiment of a container blank encapsulated with polymeric films by a method carried out in accordance with the present invention;

FIG. 5 is a perspective view of a container formed from the container blank of FIG. 4;

FIG. 6 is a diagrammatic view of a process for encapsulating a container blank with polymeric films in accordance with the present invention; and

FIG. 7 is a diagrammatic view of a second embodiment of a process for encapsulating a container blank with polymeric films in accordance with the present invention.

### DETAILED DESCRIPTION OF THE PREFERRED EMBODIMENT

As used herein, the following terms have the following meanings.

Fibreboard refers to fabricated paperboard used in container manufacture, including corrugated fibreboard.

Container refers to a box, receptacle or carton that is used in packing, storing, and shipping goods.

Moisture-resistant film refers to polymeric films that are substantially impervious to moisture. Such films are not necessarily totally impervious to moisture, although this is preferred, but the amount of moisture capable of passing through the film should not be so great that such moisture reduces the strength or other properties of the cellulose based substrate to below acceptable levels.

Thermobondable refers to a property of a material that allows the material to be bonded to a surface by heating the material.

Thermoplastic refers to a material, usually polymeric in nature, that softens when heated and returns to its original condition when cooled.

Panel refers to a face or side of a container.

Score refers to an impression or crease in a cellulose based substrate to locate and facilitate folding.

Flaps refer to closing members of a container.

Peeling refers to separation of one film from another film along a bond formed between the films.

Creep refers to movement of the film-to-film bond line that occurs when the films peel from each other when the bond is subjected to stress.

The present invention provides for the encapsulation of a cellulose based substrate with polymeric films. Cellulose based substrates are formed from cellulose materials, such as wood pulp, straw, cotton, bagasse, and the like. Cellulose based substrates useful in the present invention come in many forms, such as fibreboard, containerboard, corrugated containerboard, and paperboard. The cellulose based substrates can be formed into structures such as container blanks, tie sheets, slip sheets, and inner packings for containers. Examples of inner packings include shells, tubes, partitions, U-boards, H-dividers, and corner boards.

The following discussion proceeds with reference to an exemplary cellulose based substrate in the form of a containerboard blank, but it should be understood that the present invention is not limited to containerboard blanks.

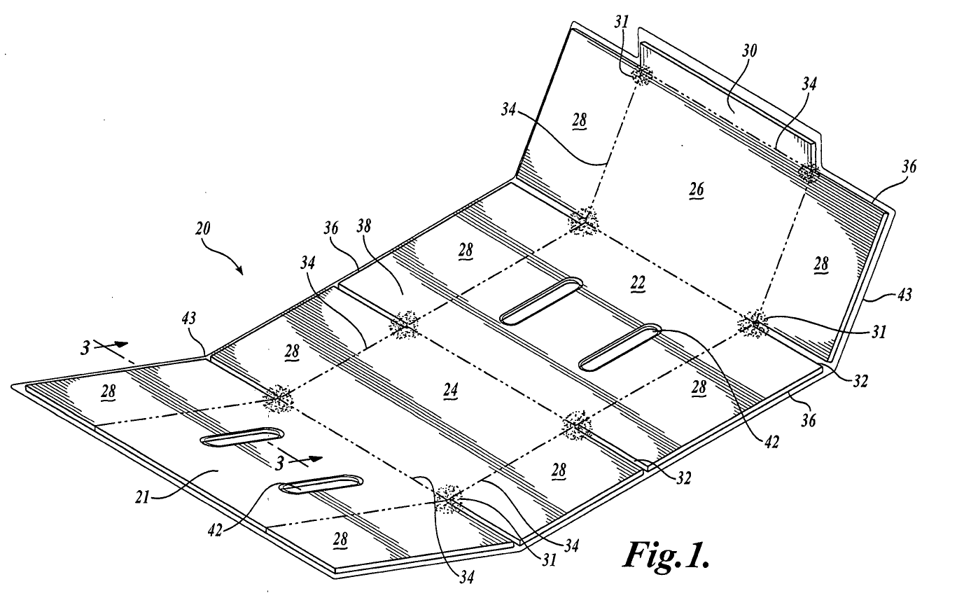

Referring to FIG. 1, a non-limiting example of a cellulose based substrate includes a container blank 20 having rectangular panels 21 and 22 that will form sidewalls of a container when the blank is folded and secured. Panels 21 and 22 are separated by rectangular panel 24 that will form an end wall of a container when the blank is folded. Extending from the edge of panel 22 opposite the edge connected to panel 24 is an additional rectangular panel 26 that will form a second end wall. The sequence of panels 21, 22, 24, and 26 define a lengthwise dimension for container blank 20. Each panel 21, 22, 24, and 26 includes two rectangular flaps 28 extending from the left edge and right edge thereof. Extending rearwardly from the rear edge of panel 26 is a narrow rectangular flap 30. Panels 21, 22, 24, and 26 and flaps 28 and 30 are separated from each other by either slots 32 defined as cuts formed in container blank 20 or scores 34. The external peripheral edge around container blank 20 defines a container blank periphery 36. As illustrated, container blank 20 has a first surface defined in FIG. 1 as the upper visible surface and a second opposite surface forming the underside of the container blank in FIG. 1. Panel 21 and panel 22 include cutouts 42 that serve as ventilation orifices, drainage orifices, or handles once container blank 20 is formed into a container by applying adhesive to panel 30 and positioning panel 30 adjacent to panel 21. While container blank 20 is illustrated with scores, cutouts and slots, it is understood that such features are not required and that a cellulose based substrate without such features may be encapsulated with polymeric films in accordance with the present invention. In the illustrated embodiment, the edge of the blank adjacent the container blank periphery and the blank edges that define the slots and cutouts are examples of exposed edges adjacent to which the polymeric films are bonded to each other by an adhesive, as described below in more detail.

Overlying and underlying container blank 20 are polymeric films 43 adhered to the container blank and bonded and sealed to each other around the container blank periphery 36 by an adhesive. Polymeric films 43 are also bonded and sealed to each other by an adhesive adjacent the exposed blank edges that define slots 32 and cutouts 42. As used herein, the term “sealed” means that overlapping portions of the film adjacent the top surface and the film adjacent the bottom surface are bonded to each other by an adhesive in a manner that substantially prevents moisture from passing through the seal. Areas 31, identified with the stippling, correspond to locations on container blank 20 where additional adhesive can be applied in order to further strengthen and reinforce films 43, as described below in more detail.

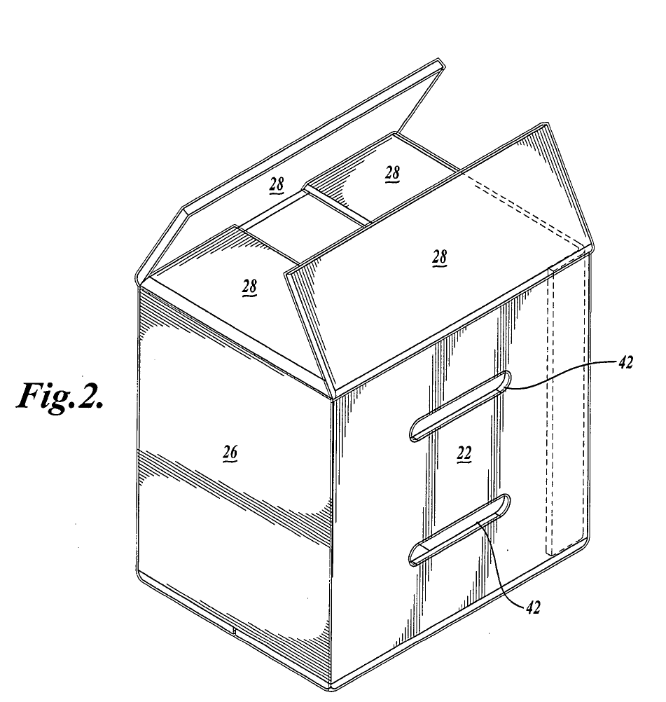

Container blank 20 can be folded and secured into a container as illustrated in FIG. 2. The numbering convention of FIG. 1 is carried forward in FIG. 2. Prior to folding container blank 20 and securing it to form a container, the portions of polymeric films 43 within slots 32 are cut. Additionally prior to folding the container, the excess polymeric film adjacent to the periphery 36 can be trimmed. Futhermore, the polymeric film spanning cutouts 42 can be cut in such a manner that a passageway is made into the interior of the container while at the same time preserving the film-to-film seal.

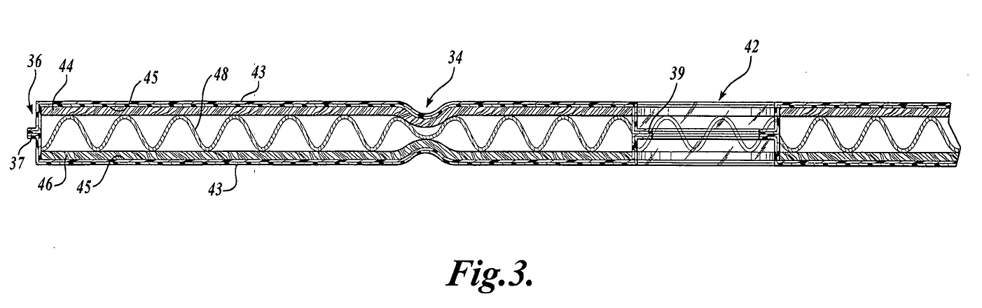

Referring to FIG. 3, container blank 20 is comprised of upper liner board 44 and lower liner board 46 spaced apart by flutes 48. An outer surface of liner board 44 is overlaid with an adhesive layer 45 and polymeric film 43. In the illustrated embodiment, an outer surface of lower liner board 46 is overlaid with an adhesive layer 45 and a polymeric film 43. While the present invention is described in the context of an embodiment wherein an adhesive is applied to both polymeric films 43, it should be understood that satisfactory results can be achieved by applying adhesive only to one of the films. The applied adhesive 45 and polymeric films 43 conform to the topographical features defined by the peripheral edge 36, scores 34 and cutouts 42. The adhesive and films conform to the topographical features by following the elevational changes in the first and second surfaces of the container blank. Preferably, adhesive 45 and films 43 conform to the shape and encapsulate the exposed edges of the container blank such as those defining slots and cutouts, and seal closely against such edges as depicted in FIG. 3. Likewise, polymeric films 43 adjacent the container blank periphery 36 are bonded to each other at 37 by adhesive 45 to provide a moisture-resistant seal. A similar moisture-resistant seal 39 is provided between the polymeric films 43 within cutout 42.

Containerboard is one example of a cellulose based substrate useful in the present invention. Particular examples of containerboard include single face corrugated fibreboard, single-wall corrugated fibreboard, double-wall corrugated fibreboard, triple-wall corrugated fibreboard and corrugated fibreboard with more walls. The foregoing are examples of cellulose based substrates and forms the cellulose based substrates may take that are useful in accordance with the methods of the present invention; however, the present invention is not limited to the foregoing forms of cellulose based substrates.

Portions of the cellulose based substrate can be crushed before applying the polymeric films. Crushing of the cellulose based substrate adjacent its peripheral edges, and the edges within cutouts and slots, has been observed to result in improved conformance of the film to the shape of the edges. Crushing of the edges can be achieved by passing the edges through a nip to temporarily reduce the caliper of the substrate and reduce its resilience to deformation. Crushing of the edges is commonly achieved by placing stiff rubber rollers adjacent to cutting knives.

Polymeric films useful in accordance with the present invention include thermobondable and thermoplastic films that are moisture-resistant. The films should cooperate with the adhesives, described below in more detail, to bond the films together and provide moisture-resistant seals between the overlapping portions of the films. The adhesive may additionally bond the films to the cellulose based substrate. Useful films may be a single-layer or may be a multi-layer, e.g., a two or more layer film. Single-layer films are preferred. The choice of a specific film composition and structure will depend upon the ultimate needs of the particular application for the cellulose based substrate. Films should be chosen so that they provide the proper balance between properties such as flexibility, moisture resistance, abrasion resistance, tear resistance, slip resistance, color, printability, and toughness.

In certain embodiments, co-extruded multi-layer polymeric films can be used. Multi-layer films provide the ability to choose an inner layer composition that cooperates with the adhesive while at the same time providing an outer layer that has properties more appropriate for the exposed surfaces of the encapsulated container.

Exemplary films include linear low density polyethylene (LLDPE) blended with low density polyethylene (LDPE), blends of LLDPE and ethylene vinyl acetate (EVA) copolymer, blends of LLDPE and ethylene acrylic acid (EAA), coextruded films comprising LLDPE and EVA layers, coextruded films of an LLDPE-LDPE blend and EVA, coextruded films having an LLDPE layer and an EAA or ethylene methacrylic acid (EMA) layer, or coextruded films having an LLDPE-LDPE layer and an EAA or EMA layer. Examples of other useful film layers include those made from metallocene, Surlyn® thermoplastic resins from DuPont Company, polypropylene, polyvinylchloride, or polyesters or combination thereof in a monolayer or multi-layer arrangement.

Film thickness can vary over a wide range. The film should not be so thick that when it is applied to a container blank it will not conform to changes in topography along the surface of the container blank created by such things as the peripheral edges, edges defined by the slots, and edges defined by the cutouts. The films should be thick enough to survive normal use conditions without losing their moisture-resistance. Exemplary film thicknesses range from about 0.7 mil (0.018 mm) to about 4.0 mil (0.10 mm).

The moisture-resistant polymeric film applied to the inner and outer surfaces of the container blank can be the same, or different films can be applied to different surfaces. Choosing different films for the respective surfaces would be desirable when the particular properties needed for the respective surfaces of the container blank differ. Examples of film properties that might be chosen to be different on the respective surfaces of the container blank have been described above. In addition to being colored, it is possible that graphics may be preprinted on the polymeric film. For food applications, the film is preferably approved for use by the United States Food and Drug Administration.

Adhesives useful in accordance with the present invention include those that cooperate with the films to bond the films together and optionally to the underlying cellulose based substrate. The adhesive and film combination should be such that the two are able to conform to the exposed edges of the container blank. Preferably, once the adhesive and film are conformed to the edges of the container blank and the adhesive has set, any peeling of the films and creep adjacent such edges is minimal. The adhesive and films should be chosen so that the bond between the films formed by the adhesive has a cohesive strength that is greater than the stresses that the bonds are exposed to during manufacturing and use of the encapsulated container. For example, the film and adhesive should be chosen so that the bond between the films formed by the adhesive has a cohesive strength that is greater than the stresses that promote peeling of the films adjacent the container blank edges. By choosing the films and adhesives so that the bond between the films formed by the adhesive has a cohesive strength greater than the stresses promoting peeling, creep of the peeling can be minimized. Preferably, the adhesive will remain with the polymeric films when the encapsulated container blank is re-pulped, e.g., during recycling. Exemplary types of adhesives are known as hot melt adhesives, and include elastic styrene-isopropene-styrene block copolymers. Other useful adhesives include ethylene vinyl acetate adhesives, amorphous polyolefin adhesives, polypropylene adhesives, and pressure sensitive adhesives. Preferably, the adhesives have a viscosity ranging from about 1,000 to 15,000 centipoise at the application temperature. While hot melt adhesives are preferred, it should be understood that non-hot melt adhesives may find utility in the present invention and that other compositions of adhesives may also be used.

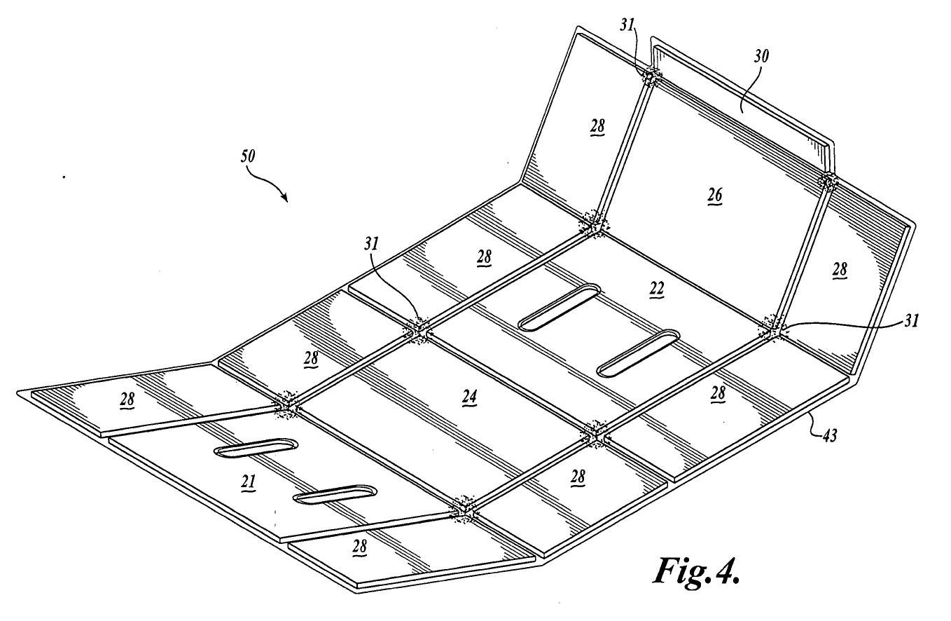

Referring to FIG. 4, methods of the present invention can produce a container blank 50 wherein panels 21, 22, 24, and 26 are structurally separated from each other as well as from flaps 28 and flap 30. In this embodiment, polymeric resistant films 43 function as a hinge between the respective panels of the container blank. As with FIG. 1, container blank 50 in FIG. 4 is illustrated with stippled areas 31 that identify locations where additional adhesive may be added to reinforce films 43.

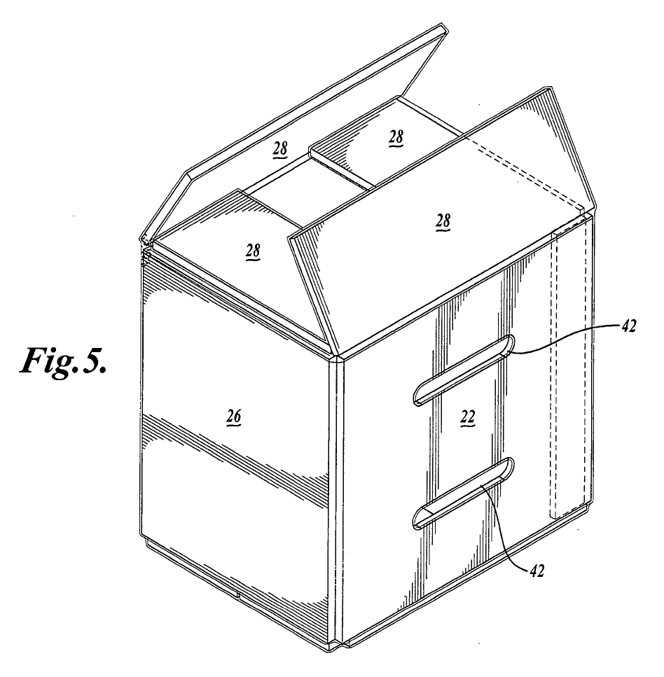

Container blank 50 can be folded and secured into a container as illustrated in FIG. 5. The numbering convention of FIG. 4 is carried forward in FIG. 5.

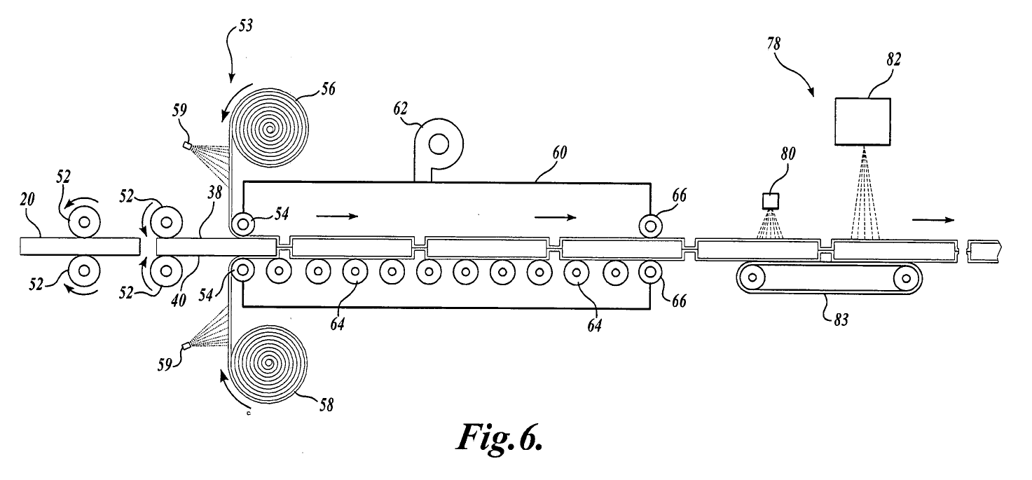

Referring to FIG. 6, a method carried out in accordance with the present invention for producing a cellulose based substrate encapsulated in a polymeric film on a continuous basis, as opposed to a batch basis is illustrated and described in the context of a containerboard blank. In the illustrated embodiment, a container blank 20 from a source of container blanks (not shown) is delivered via a conveyance system illustrated as two sets of rollers 52 to a film application stage 53. At film application station 53, films 56 and 58 are unrolled from the supply rolls and delivered to a nip formed by rollers 54. Before entering the nip at rollers 54, adhesive is applied to the surface of the respective films that will contact the upper surface 38 and lower surface 40 of container blank 20. In this embodiment, adhesive is applied to both films 56 and 58; however, as noted above, the present invention can be carried out by applying adhesive to only one of films 56 or 58. The following description applies equally well to an embodiment wherein adhesive is applied to only one of the films 56 or 58.

In the embodiment of FIG. 6, adhesive is applied to substantially all of the surface of films 56 and 58, particularly those portions where direct film-to-film bonding is necessary, e.g., around the container blank periphery and adjacent the edges defined within cutouts and slots. It should be understood that it is not required that adhesive be applied to substantially all of the surfaces of films 56 and 58. Satisfactory film-to-film bonding can be achieved by applying adhesive only to those portions of the films that overlap around the container blank periphery and adjacent the edges defined within cutouts and slots. Adhesive is preferably provided by a non-contact application method in order to minimize burn-through or tearing of films 56 and 58. An exemplary application process includes applying a hot melt adhesive as carefully controlled extruded fibers filaments of the adhesive applied in a crossing pattern. Equipment suitable for applying adhesives in this manner is available from Nordson Corporation of Dawsonville, Ga. Adhesive can be applied in other manners such as slot die methods wherein the film contacts a die as the adhesive is dispensed or spray type application methods.

The location where the adhesive is applied can vary; however, when the adhesive is heated, it is preferable to add the adhesive as close to the nip formed by rollers 54 as possible in order to avoid premature cooling of the adhesive. In order to facilitate wetting of the film surfaces by the adhesive, the film surfaces can be treated such as by corona treatment (not shown). The adhesive should be applied at temperatures that do not adversely affect the moisture resistant properties of the film and do not damage the film or the underlying container blank. The application rate for the adhesive can vary. Exemplary application rates include about 1 gram per square meter to 15 grams per square meter. When necessary, more adhesive can be applied to those areas where added bond strength is desirable such as areas prone to tears or where added thickness can reduce abrasion damage. After the adhesive is applied, film 56 is provided adjacent upper first surface 38 of container blank 20, and film 58 is provided adjacent lower second surface 40 of container blank 20. Films 56 and 58 have a width dimension measured in the cross-machine direction that is greater than the width of container blank 20. Thus, portions of the films 56 and 58 extend beyond the edges of the blanks that are parallel to the direction that the blanks travel. In the direction that the blanks travels through the process, individual blanks are spaced apart. Accordingly, films 56 and 58 bridge the space between the trailing edge of one blank and the leading edge of the next blank.

The combination of container blank 20, first film 56 and second film 58 passes through the nip formed by rollers 54. The nip formed by rollers 54 defines an inlet to a pressure chamber 60. Pressure chamber 60 is in fluid communication with a pump 62 capable of increasing the pressure within pressure chamber 60. Pressure chamber 60 also includes a plurality of rollers 64 for supporting the combined container blank 20, first film 56 and second film 58 through pressure chamber 60. Pressure chamber 60 is operated at a pressure greater than the pressure outside pressure chamber 60. As described below in more detail, the elevated pressure within pressure chamber 60 promotes the conformance of films 56 and 58 to container blank 20 around the container blank peripheral edges as well as within any slots or cutouts provided in the container blank. The container blank 20 and films 56 and 58 exit chamber 60 through the nip created by rollers 66. The nips created by rollers 54 and 66 are preferably as airtight as possible in order to maintain the elevated pressure within chamber 60. Alternative means can be used besides the rollers to prevent pressure loss from chamber 60, such as air locks and the like. From pressure chamber 60, container blanks 20 encapsulated by films 56 and 58 pass to trimming stage 78 described below in more detail.

As noted above, films 56 and 58 are dimensioned such that the respective films extend beyond the container blank periphery in the cross machine direction perpendicular to the travel of the container blank 20. In this manner, film 56 comes into contact with film 58 adjacent the container blank periphery and within slots and cutouts where the films overlap. The presence of adhesive between these overlapping portions of the film causes the films to be held together. As the adhesive cools, the cohesive strength of the bond formed by the adhesive between the films increases. Preferably, the adhesive bonds the films to each other at substantially all points where the films overlap. In this manner, the films form an envelope that substantially encapsulates the container blank. As described below in more detail, the envelope is formed in a manner such that a pressure differential may be provided between the environment inside the envelope and the environment outside the envelope. An envelope formed around the container blank is suitable so long as it encapsulates the blank in a manner that is capable of supporting a pressure differential between the inside of the envelope and the outside. For example, two films bonded to each other adjacent the leading and trailing edges of a container blank, but not the parallel side edges, would not substantially encapsulate a blank so as to be able to support a pressure differential between an environment between the films and an environment outside the films; however, an envelope formed by the films wherein the films are intermittently or reversibly bonded around all exposed edges of the container blank would be satisfactory, because a pressure differential can be created between the interior of the envelope and the environment exterior to the envelope.

Conformance of the two films to the container blank periphery, slots, and cutouts, is promoted by providing a pressure differential between an environment within the envelope described above and the environment exterior of such envelope. More specifically, the container blank and films are treated so that there is a point in the manufacturing process after the adhesive has been applied to at least one of the films where the pressure within the envelope is lower than the pressure exterior to the envelope. Satisfactory conformance of the films is evidenced by an absence of air bubbles at the interface between the films and the container blank, as well as robust and continuous seals around the exposed edges of the container and the edges exposed within the cutouts and slots. The degree of the conformance of the films to the container blank can be evaluated by assessing the distance between the film-to-film bond line and the exposed edge of the container blank. As the distance between the film-to-film bond line and the container blank edge increases, the degree of conformance of the film to the container blank edge decreases. Shorter distances between the container blank edge and the film-to-film bond line are more desirable than larger distances.

As used herein, the phrase “pressure differential” refers to a difference in pressure between the inside of the envelope and the exterior of the envelope that is attributable to more than the pressure differential that would be observed by simply reducing the temperature of gas within the envelope without a phase change. For example, in the context of the present invention, a pressure differential can be provided by moving the envelope from a low pressure environment to a higher pressure environment, with or without cooling of the gas within the envelope.

Pressure within pressure chamber 60 can vary and should be chosen so that crushing of the container blank is avoided while at the same time, conformance of the film to the blanks is high. The pressure in chamber 60 should not be so high that excessive gas loss cannot be prevented by rollers 54 and 66. Rollers 54 and 66 should be operated at a pressure that is high enough to minimize gas loss while at the same time not being so high that unwanted crushing of the container blank occurs. Examples of suitable rollers include silicone rubber rollers that are either patterned or non-patterned. The particular pressure within the chamber will depend upon a number of factors, including the thickness and malleability of the film. Thinner more malleable films will conform to the container blank with less pressure than thicker, stiffer films. The chamber should be long enough so that the adhesive is able to gain adequate cohesive strength through cooling as it passes through pressure chamber 60. As discussed above, an adequate cohesive strength is one that is greater than the tension force that promotes peeling of the films from each other. The length of pressure chamber will also depend upon the speed of the blanks passing through the chamber. Exemplary pressures within the pressure chamber can range from about 2 to 20 pounds per square inch. Blank speeds ranging from about 1 to 500 feet (0.3 to 150 meters) per minute are exemplary.

Within trimming stage 78, sensor 80 and laser 82 cooperate to trim away excess polymeric film around the container blank periphery and within the slots and cutouts without compromising the water-resistant seals. In order to ensure the accuracy of the film trimming, trimming stage 78 preferably employs a conveyance system 83, such as a vacuum belt that minimizes movement of the container blank and films during the laser trimming process. Alternatives to laser trimming include die cutting or hand trimming.

By trimming away portions of the polymeric films within the cutouts, openings can be provided for ventilation, drainage, or for allowing the cutouts to serve as handles for the container. It is preferred that trimming of the films within the cutouts and slots be carried out as soon as possible after the adhesive forms the film-to-film bonds. Peeling of the films occurs when the tension on the films is greater than the cohesive strength of the film-adhesive-film bond. When the films conform to the contour of the edges of the container blank, the films are put under tension that can cause peeling. Peeling is evidenced by the films separating along the line where the upper film meets the lower film. As the films begin to peel, this line begins to creep away from the edge of the container blank. As peeling may increase over time, it is preferable to minimize the time between when the encapsulated blank leaves the pressure chamber and the time when the trimming occurs. The films adjacent the exposed edges should be trimmed as close as possible to the container blank edges without compromising the film-to-film bond at the time of trimming. The distance between the edge of the container blank and the edge of the trimmed film should be great enough that any peeling of the films does not extend to the trimmed edge of the films and compromise the seal between the films.

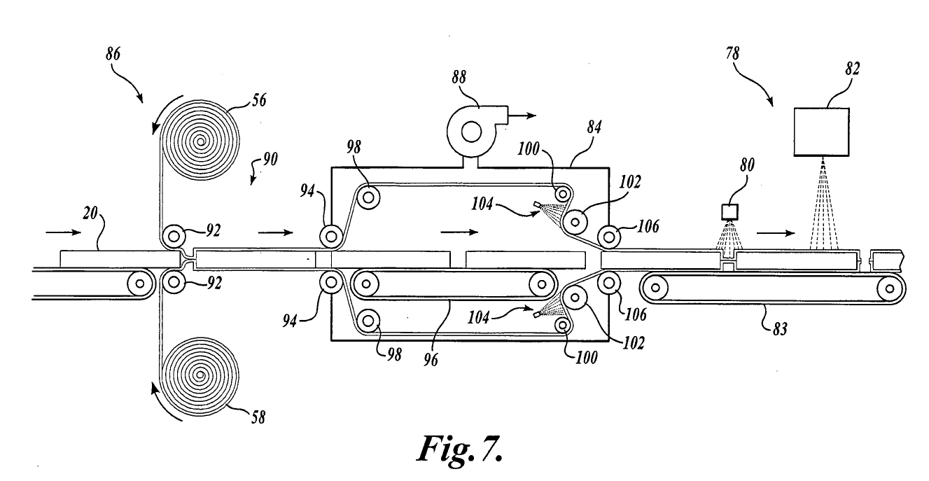

Referring to FIG. 7, in an alternative embodiment, pressure chamber 60 of FIG. 6 has been replaced by a vacuum chamber 84. The system illustrated in FIG. 7 includes trimming stage 78 identical to the trimming stage described above with respect to FIG. 6. The system of FIG. 7 also includes a film application stage 86 that is identical to the film application stage 53 in FIG. 6 with the exception that adhesive applicators 59 are omitted.

Vacuum chamber 84 is an air tight chamber in fluid communication with vacuum pump 88. The inlet of vacuum chamber 84 includes rollers 94 defining a nip designed to allow a container blank 20 and associated films 56 and 58 to pass into chamber 84 without compromising the reduced pressure therein. Upstream from rollers 94 are a pair of rollers 92 that receive films 56 and 58 and container blank 20. Films 56 and 58 are positioned adjacent to the upper and lower surface of blank 20 at rollers 92. When container blank 20 includes corrugated fibreboard and the flutes are oriented parallel to the direction of travel of the blanks, when the leading edge of the container enters vacuum chamber 84, a suction is created at the trailing end of the container blank. This suction draws films 56 and 58 against the trailing end of container blank 20 and serves to create a seal that prevents air from being drawn into vacuum chamber 84 through the corrugated flutes of container 20.

Vacuum chamber 84 includes a conveyor belt 96 for transporting blanks 20 through vacuum chamber 84. Vacuum chamber 84 also includes a combination of rollers 98, 100 and 102 for separating films 56 and 58 from container blank 20 and delivering the films to an adhesive applicator 104 where adhesive is applied to a surface of the films 56 and 58 before they are recombined with blanks 20. As noted above, in the illustrated embodiment, adhesive is shown as being applied to surfaces of both films 56 and 58; however, this embodiment is not limited to applying adhesive to both films and accordingly, adhesive can be applied to either film 56 or 58. The exit of vacuum chamber 84 includes a pair of rollers 106 defining an air tight nip at the exit of chamber 84.

In accordance with this embodiment, container blanks 20 are combined with films 56 and 58 at film application stage 86. The web comprising the container blank 20 and films 56 and 58 enter vacuum chamber 84 at the nip formed by rollers 94. As films 56 and 58 enter vacuum chamber 84, they are separated from container blank 20 and delivered to adhesive applicators 104 where adhesive is applied to the surface of at least one of the films. As soon as possible after adhesive applicators 104, films 56 and 58 are recombined with container blanks 20. The amount of time between when adhesive is applied to the films and when the films are applied to the container blank should be minimized in order to avoid the adhesive losing its adhesive properties due to cooling.

The combination of films 56 and 58 and the adhesive form an envelope encapsulating container blank 20. Pressure within this envelope will be approximately equal to the pressure within vacuum chamber 84. Accordingly, as the envelope exits vacuum chamber 84, it will be exposed to the environment outside vacuum chamber 84 which preferably is atmospheric pressure. The pressure differential between the internal environment within the envelope and the environment outside the envelope promotes the conformance of the film to the container blank, including the exposed edges around the container blank periphery and edges defined within cutouts and slots. After the adhesive cools, the web of films, adhesive and container blank is delivered to trimming stage 78 where the encapsulated blank is processed as described above.

In the embodiment of FIG. 7, it is preferred that the films as they exit the vacuum chamber adhere to each other at substantially all points where they overlap so that the films form an envelope that substantially encapsulates the container blank. While it is preferred that the films are reversibly or intermittently bonded to each other adjacent all four edges of the container blank and within any slots and cutouts of the container blank, as discussed above, an envelope formed around the container blank is suitable so long as it is capable of supporting a pressure differential between the inside of the envelope and the outside.

Exemplary vacuum conditions within vacuum chamber 84 can range from about 200 mm Hg to about 300 mm Hg. Vacuum within vacuum chamber 84 should be chosen so that it is far enough below the pressure outside vacuum chamber 84 so that acceptable conformance of films 56 and 58 to container blank 20 is achieved after the encapsulated blank exits the vacuum chamber. Vacuum within vacuum chamber 84 should not be so low that film damage occurs, the container blank experiences loss of caliper or the vacuum cannot be maintained by the seals at the inlet and outlet of the vacuum chamber. The description regarding the types of films, adhesives, film properties, adhesive properties, adhesive loading, line speeds and the like described above with respect to FIG. 6 are also applicable to the embodiment of FIG. 7.

Although not illustrated, other methods of promoting the conformance of the polymeric films to the container blank can be used. One example of such method includes a hot air knife capable of delivering a focused stream of air at the encapsulated container blank as it leaves the pressure chamber 60 of FIG. 6 or the vacuum chamber 84 of FIG. 7.

With the reference to FIGS. 6 and 7, the inlets and outlets of the respective vacuum chamber 60 and pressure chamber 84 are described as including rollers. It should be understood that combinations of other types of components such as brushes, soft rollers, and wiper blades that allow for the entry and exit of the container blanks and films into the vacuum chamber or pressure chamber without substantially compromising the reduced or increased pressure within the respective chambers can be utilized. For example, one alternative includes a combination of a soft roller and a flexible wiper for sealing the upper surface of the combination of a container blank and film to the vacuum/pressure chamber and a brush for sealing the lower surface of the blank and film to the vacuum/pressure chamber.

The present invention has been described above in the context of a containerboard blank encapsulated with a polymeric film. The containerboard blank can be formed and secured to provide a moisture-resistant container. In addition, such a moisture-resistant container can be combined with other structural components such as inner packings, described above, that may be encapsulated with a polymeric film, or may not be encapsulated with a polymeric film. Furthermore, containers can be provided wherein the container body is not encapsulated with a polymeric film while certain inner packing structural components are encapsulated with a polymeric film. In addition, cellulose based inner packings encapsulated with a polymeric film can be combined with non-cellulosic based container bodies and cellulose based container bodies encapsulated with polymeric film can be combined with non-cellulosic inner packing structural components.

While the preferred embodiment of the invention has been illustrated and described, it will be appreciated that various changes can be made therein without departing from the spirit and scope of the invention.

1. A method for encapsulating a cellulose based substrate with a polymeric film, the method comprising:
providing a cellulose based substrate, the cellulose based substrate having a first surface, a second surface opposite the first surface, and a cellulose based substrate periphery;
providing a first polymeric film;
applying an adhesive to at least a portion of the first polymeric film;
providing a second polymeric film;
positioning the first polymeric film treated with adhesive adjacent the first surface of the cellulose based substrate such that the first polymeric film extends beyond the cellulose based substrate periphery;
positioning the second polymeric film adjacent the second surface of the cellulose based substrate such that the second polymeric film extends beyond the cellulose based substrate periphery, the first polymeric film and second polymeric film defining an envelope that substantially encapsulates the cellulose based substrate; and
providing a pressure differential between an environment within the envelope and an environment exterior of the envelope.

2. The method of claim 1, further comprising the step of applying adhesive to at least a portion of the second polymeric film.

3. The method of claim 1, wherein the step of providing a pressure differential includes sequentially exposing the envelope to a first pressure environment and a second pressure environment, pressure of the first pressure environment being different than the pressure of the second pressure environment.

4. The method of claim 1, further comprising the step of bonding a portion of the first polymeric film that extends beyond the cellulose based substrate periphery to a portion of the second polymeric film that extends beyond the cellulose based substrate periphery with the adhesive.

5. The method of claim 1, wherein the cellulose based substrate is a container blank.

6. The method of claim 5, wherein the container blank includes features selected from slots, cutouts, and scores.

7. The method of claim 1, wherein the cellulose based substrate comprises inner packings for a container selected from U-boards, H-boards and corner boards.

8. The method of claim 1, wherein the first polymeric film and second polymeric film comprise identical structures and composition.

9. The method of claim 1, wherein the first polymeric film and second polymeric film are different in structure.

10. The method of claim 1, wherein the first polymeric film and the second polymeric film are different in composition.

11. The method of claim 1, further comprising the step of trimming the first polymeric film and/or the second polymeric film.

12. The method of claim 11, wherein the step of trimming is carried out using a laser.

13. The method of claim 1, further comprising the step of treating the first polymeric film to increase its ability to be wet by the adhesive.

14. The method of claim 13, wherein the step of treating the first polymeric film to increase its ability to be wet by the adhesive comprises a corona treatment.

15. The method of claim 1, further comprising reducing the resilience of a portion of the cellulose based substrate adjacent the cellulose based substrate periphery.

16. The method of claim 1, further comprising the step of reinforcing selected portions of the first polymeric film by applying adhesive to such selected portions.

17. The method of claim 1, wherein the step of applying an adhesive to at least a portion of the first polymeric film further comprises applying adhesive to portions of the first polymeric film that extend beyond the cellulose based substrate periphery.

18. The method of claim 17, further comprising the step of adhering portions of the first polymeric film that extend beyond the cellulose based substrate periphery to portions of the second polymeric film that extend beyond the cellulose based substrate periphery.

19. The method of claim 6, further comprising the step of bonding the first polymeric film to the second polymeric film adjacent the cutouts or slots.
